(19) United States
(12) Patent Application Publication
(10) Pub. No.: US 2005/0147082 A1
(43) Pub. Date: Jul. 7, 2005

(54) Apparatus to control PHY state of network devices

(76) Inventors: Asha R. Keddy, Portland, OR (US); Jeyaram Krishnasamy, Portland, OR (US); Jeremy L. Rover, Beaverton, OR (US)

Correspondence Address: TROP PRUNER & HU, PC, 8554 KATY FREEWAY, SUITE 100, HOUSTON, TX, 77024, US

(21) Appl. No.: 10/748,498

(22) Filed: Dec. 30, 2003

(51) Int. Cl. H04L 12/28

(52) U.S. Cl. 370/351

(57) ABSTRACT

A technique for programmatically controlling a state of the PHY of a network device. In one embodiment, a first network interconnect device (for example, a hub) comprises a device port coupled to a network device and comprises an uplink port coupled to a second network interconnect device (for example, a switch or a router). Transmission, under program control, of a predetermined signal from the second network interconnect device to the uplink port of the hub causes network devices that are coupled to device ports of the hub to connect/disconnect to/from the network. In one embodiment, the predetermined signal (which may be the heartbeat signal that is familiar to Ethernet networks, for example), causes the power state of the network device to go up and down (become active or inactive), thereby affording the capability to programmatically control the PHY of network devices.

### BACKGROUND

The operation of various network architectures, such as LANs (local area networks), MANs (metropolitan area networks), and WANs (wide area networks), is in part predicated on network interconnect devices such as switches, routers, hubs and the like. In general, these network interconnect devices operate to distribute or direct signals to network devices (i.e. DTE, (data terminal equipment)). With respect to such network interconnect devices, there currently exists a programmatically controllable interface to configure ports, IP (Internet Protocol) configurations, routing information and other aspects of network interconnect device configuration. However, there as yet is not available a mechanism to programmatically control the physical layer (PHY) of network devices. In particular, there does not exist a capability to control, via software or other programming techniques, the power state of a DTE network device. Such capability would be useful in many situations, including circumstance that call for the network device to be selectively connected to and/or disconnected from the network in question.

In this regard, there has been identified a need for a technique that enables a network to change state on the fly, as by selectively controlling a state of the PHY of a network device, without manually reconfiguring or restarting the network devices in question.

### BRIEF DESCRIPTION OF THE DRAWINGS

The subject Apparatus to Control PHY States of Network Devices may be better understood by, and it many features, advantages and capabilities made apparent to, those skilled in the art with reference to the Drawings that are briefly described immediately below and attached hereto, in the several Figures of which identical reference numerals (if any) refer to identical or similar elements, and wherein:

FIG. 1 is a graphical representation of a computer network environment in which the subject invention may be implemented.

FIG. 2 is a graphical representation of a network interconnect device, specifically, a network hub, in accordance with one embodiment of the invention.

FIG. 3 is a graphical representation of the manner in which a network device, a first (slave) network interconnect device, and a second (master) network interconnect device may be arranged in accordance with one embodiment of the invention.

FIG. 4 is a graphical representation of an alternative embodiment of the invention in which a master network interconnect device is operable to control a PHY state of numerous DTE network devices through a concatenated arrangement of slave network interconnect devices.

Skilled artisans appreciate that elements in Drawings are illustrated for simplicity and clarity and have not (unless so stated in the Description) necessarily been drawn to scale. For example, the dimensions of some elements in the Drawings may be exaggerated relative to other elements to promote and improve understanding of embodiments of the invention.

### DETAILED DESCRIPTION

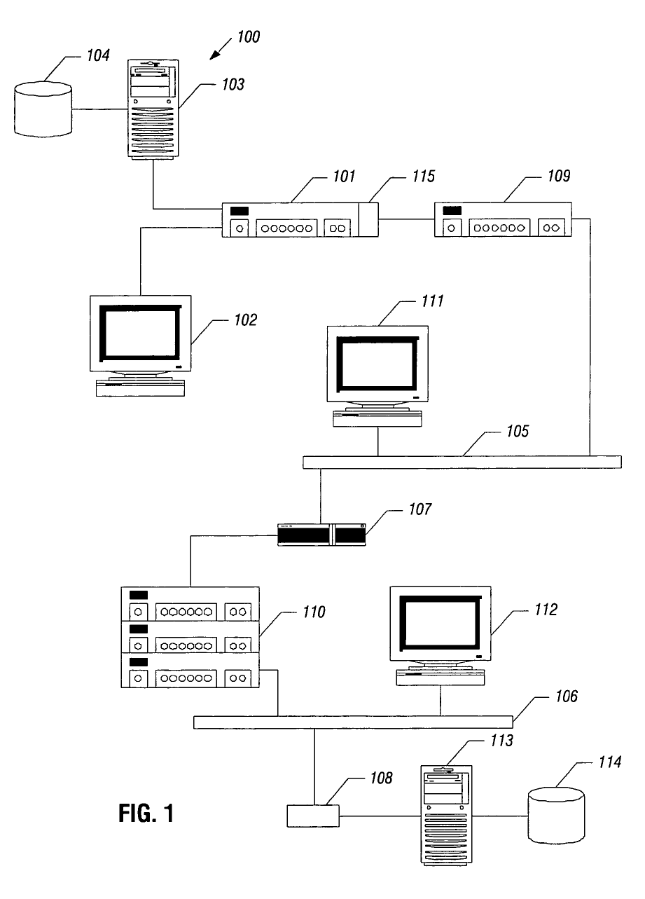

FIG. 1 is a graphical illustration of a typical computer network environment 100 in which the present invention, in one embodiment, may be implemented. Computer network 100 maybe perceived as an appropriate combination of high-speed (100 Mbps, for example) and low-speed (10 Mbps, for example) Ethernet components. For pedagogical purposes, the subject invention will be described here largely in the context of an Ethernet LAN. However, skilled practitioners readily appreciate that the scope of the invention is not limited to use in a particular network architecture.

High-speed Ethernet components may include a Fast Ethernet hub 101, which may be coupled to a network management station 102. Network management station 102 is coupled to a high-speed port 101a of hub 101. In one embodiment, a file server 103 supporting a database 104 is coupled to another of the high-speed ports on hub 101.

In FIG. 1, low-speed Ethernet components include 10 Mbps Ethernet buses 105 and 106, network interconnect devices such as router 107, Ethernet switch 108, 10 Mbps Ethernet hubs 109 and 110, and DTE (data terminal equipment) network devices, such as workstations 111 and 112, file server 113 and database 114. The high-speed and low-speed subnetworks may be interconnected (i.e., bridged) at a network interconnect port 115 on Fast Ethernet hub 101.

It is to be understood that computer network 100 is presented as an environment typical of those in which the subject invention may be deployed. Skilled practitioners understand that the invention is applicable to a myriad of network configurations. However, it is likely that such networks will include network interconnect devices such as hubs 101, 109 and 110, router 107, and switch 108, as well as other network interconnect devices now existing or hereafter devised. In addition, computer network 100 is intended to be representative on networks that include numerous kinds of DTE network devices, such as PCs (personal computers), printers, workstations, etc.

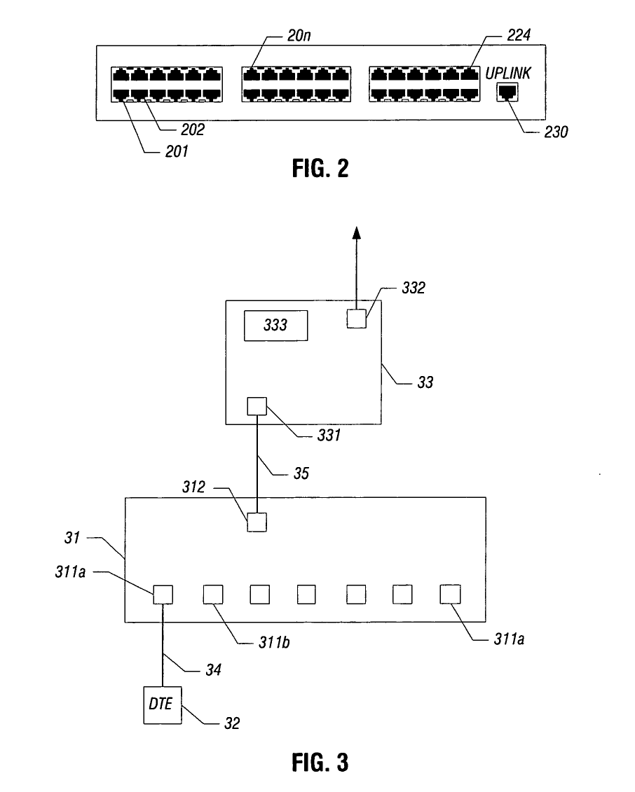

Directing attention now to FIG. 2, depicted therein is a graphical representation of a hub 200 that may be deployed, in accordance with one embodiment of the invention, in a network environment, such as network 100, for example. In one embodiment, hub 200 comprises a plurality of network device ports 201, 202, . . . , 20n, . . . , 204 to which DTE network devices such as computers, workstation, printers and the like may be coupled. In FIG. 2, hub 200 is shown to have 24 network device ports, but the invention is not limited to a hub having a specific number of network device ports.

In addition to network device ports 201, . . . , 224, hub 200 also comprises at least one uplink port 230. Uplink port 230 may be used to couple hub 200 to another network interconnect device, such as another hub having either similar or different performance characteristics, or to different type of network interconnect devices, such as a switch, a router or the like. Associated with each of ports 201, . . . , 224 and 230 is a transceiver (not shown) that, inter alia, transmits signals over, and receives signals from, the network medium to which the respective ports are coupled. In an Ethernet for example, the network medium may be thin coaxial cable, thick coaxial cable, twisted pair and the like, depending on applicable system requirements. The transceiver, which may also be referred to as an MAU (for media attachment unit), provides the interface between the hub and the common medium to which the hub is attached. In general, the transceiver, or MAU, performs functions of the PHY, including conversion of digital data from the network (e.g., Ethernet) interface, collision detection, and injection of bits into its network. The transceiver is also responsible for transmitting a predetermined signal, such as the familiar “heartbeat” pulse, that indicates connection of the hub to the network medium. That is, the heartbeat signal, or an equivalent, signifies a “link-up” or a “link-down” condition.

FIG. 3 is a graphical representation of the manner in which a network device, a first network interconnect device (i.e., a hub) and a second network interconnect device (e.g., a switch or a router) may be arranged in accordance with one embodiment of the invention. In a manner that will be made clear imminently below, the arrangement of FIG. 3 enables a state of the PHY of the network device to be programmatically controlled. In the context of the subject invention, “programmatic” control is intended to imply control other than by manual intervention, as under the control of a software program, for example. However, programmatic control also includes operations that, although perhaps precipitated by a manual action, are largely performed through program instructions.

That is, by virtue of the subject invention, a state of the PHY of the network device is rendered amenable to program control, not by virtue of software that is necessarily incorporated in the hub device, but rather through software accessible in the switch or the router, for example.

Referring now to FIG. 3, the interconnection arrangement depicted there includes a hub 31 that, in one embodiment, comprises a plurality of DTE network device ports 311, 312, . . . , etc. In one embodiment, hub 31 may provide 24 network device ports; but the number of such ports provided by hub 31 is not a limitation on the scope of the invention. The network device ports are coupled to respective DTE network devices through a respective associated transmission channel or channels. For simplicity, only one network device, device 32, is illustrated in FIG. 3. Network device 32 is coupled to hub 31 through an appropriate transmission channel 34. In an Ethernet, channel 34 may comprise CAT5 coaxial cable. In other networks the transmission channel may be optical fiber, twisted pair, a wireless medium, etc.

Hub 31 is, in turn, coupled at an uplink port 312 through a transmission channel 35 to a second network interconnect device 33 at a port 331 of network interconnect device 331. For present purposes, it may be assumed that network interconnect device 33 is an Ethernet switch but other interconnect devices, including routers and the like, are also contemplated by the invention. Transmission channel 35 may be assumed to be a medium identical to that of channel 34, but such is not necessarily the case. Switch 33 may itself be connected to other components in the network or may be coupled to a disparate network.

As to operation, it is understood by those having ordinary skill in the art that in many LAN protocols, including Ethernet as specified in IEEE 802.3 standard, network components, such as hub 31, switch 33 and network device 32, signal their respective presence on the network through the generation and propagation of a predetermined signal. In the case of an Ethernet, for example the predetermined signal is the “heartbeat” pulse. The heartbeat pulse establishes a “link up” condition at the interface between two devices at opposite ends of a transmission channel.

As to operation, recall that as indicated above, in a conventional LAN, such as depicted in FIG. 1 for example, there exists no mechanism to programmatically control the PHY of the DTE network device such as workstation 102. That is in order to disconnect workstation 102, there must occur some manual intervention by, for example, a technical to physically disconnect a cable from a connector. The requirement for manual intervention is obviated by the arrangement of FIG. 3.

In accordance with the embodiment of FIG. 3, a bridging hub 31 couples DTE network device 32 to switch 33. Specifically, DTE network device 32 is coupled through a transmission channel (e.g., cable) to a network device port 311a of hub 31. Uplink port 312 of hub 31 is coupled through a transmission channel 35 to an output port 331 of switch 33. Switch 33 may be coupled at port 332 to other network interconnect devices (not shown), to a bus, or to another network.

Recall that there exists in conventional network interconnect devices, such as switch and hub, no mechanism to programmatically control a state of the PHY of either network interconnect devices or DTE network device. However, conventional network interconnect devices such as switch 33 do have the capability to generate the heartbeat pulse under program control. In a manner to be presently revealed, generation, under program control, of the heartbeat pulse by switch 33 may be utilized to automatically connect network device 32 to, and disconnect network device 32 from, the network. In this sense, among others to be described below, the PHY of DTE network device 32 may be seen to be programmatically controllable. This capability is realized through the inclusion of hub 31.

As to operation, assume at the outset that all devices included in FIG. 3 are appropriately interconnected and active, as indicated in FIG. 3. Further assume that a reason exists to disconnect DTE network device 32 from the then-existing network configuration. Switch 33 is then programmatically caused to transmit a predetermined signal over transmission channel 35 to uplink port 321 of hub 31. The predetermined signal may, in accordance with the invention, assume a myriad of forms as required in the judicious exercise of one having ordinary skill in the art. In one embodiment, the predetermined signal is the heartbeat signal.

The appearance of the heartbeat pulse at uplink port 312 is detected by circuitry (not shown) in hub 31, and is coupled to the transceiver that is associated with, for example, network device port 311a. In one embodiment, detection of the heartbeat pulse may cause the transceiver to transmit a “link down” signal over channel 34 to DTE network device 32. Alternatively, detection may cause power to be deprived to the transceiver. Regardless the technique employed, detection of the heartbeat pulse causes, directly or indirectly, DTE network device 32 to experience a “link down” condition. That is, DTE network device 32 is caused to be effectively disconnected from the network.

Alternatively, in order to connect DTE network device 32 to the network under program control, switch 33 is again caused to transmit a heartbeat to uplink port 312. The heartbeat is detected and conveyed to the transceiver so that the transceiver generates a link-up signal for distribution to DTE network device 32, thereby causing device 32 to be connected to the network.

With continued reference to FIG. 3, note that the arrangement depicted there may be considered one that includes a “master” interconnect device, e.g., switch 33, that is operable to generate and transmit via channel 35 a predetermined signal to a “slave” interconnect device, e.g., hub 31. In one embodiment, the predetermined signal may be the heartbeat signal that operates to effectively connect/disconnect hub 31 to/from switch 33, as well as the network to which switch 33 may be coupled.

As currently configured, interconnect network devices including and similar to switch 33 possess the capability to generate the heartbeat signals under program control, i.e., without manual intervention. In general, this capability is realized in switch 33 through embedded programming and associated embedded processing capability. (For simplicity, the embedded processing structure is not depicted in FIG. 3.)

In one embodiment of the invention, programmatic control of switch 33, at least insofar as related to the generation of the predetermined signal, may be achieved by a machine-readable storage medium 333. Storage medium 333 may be present in any one of numerous available instantiations, such as, for example, semiconductor ROM (read only memory), flash memory, dynamic or static RAM (random access memory), CMOS (complementary metal/oxide/semiconductor) memory (with or without battery back-up), and the like. Storage medium 333 contains instructions that, when executed on switch 33, are effective to cause switch 33 to transmit the predetermined signal over channel 35 to hub 31. In this manner, execution of the instructions controls a state of the PHY of DTE network device 32 that is coupled to a device port 311a of the hub 31.

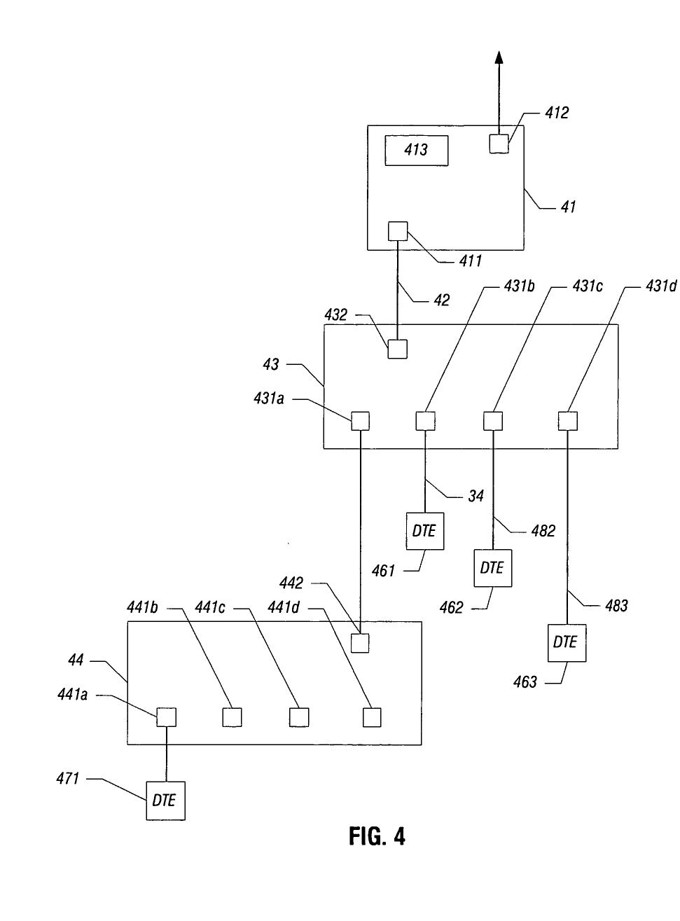

In an alternative embodiment of the invention, depicted in FIG. 4, a single (master) network interface device that is programmatically controllable may operate to control a state of the PHY of a number of serially connected concatenated slave network interconnect devices. In this manner, a single control signal emanating from the master network interconnect device effectively controls DTE network devices that are respectively coupled to each of the slave network interconnect devices.

In the concatenated arrangement of FIG. 4, a first (master) network interface device 41 is coupled from an output port 411 through a transmission channel 42 to a second (slave) network interface device 43. As suggested herein above, first network interface device 41 may be a switch or a router, and second network interface device 43 may be a hub. Hub 43 is coupled from uplink port 432 through channel 42 to network interface device 41. Hub 43 provides a plurality of device ports 431a, 431b, 431c and 431d. Device ports 431b, 431c and 431d may be coupled to respective network devices 461, 462 and 463.

As illustrated in FIG. 4, network device port 431a of hub 43 is coupled through a transmission channel 45 to a third network interface device 44 at an uplink port 442. Network interface device 44 may, in one embodiment, also be a hub. For reasons deemed apparent from FIG. 4, hub 44 may be considered concatenated to, or with respect to, hub 43. Hub 44 itself provides a plurality of output ports, or network device ports 441a, 441b, 441c, and 441d, that are coupled to respective network devices 471, 472, 473 and 474.

As to operation, in a manner similar to that which has been previously described herein, a first (i.e., master) network interface device, in the form of, for example, switch 41 is operable to transmit a predetermined signal from output port 411, over channel 42, to uplink port 432 of hub 43. Again, the nature of the predetermined signal indicates, and enables hub 43 to detect, alternatively, a “link-up” or “link-down” condition. Upon occasions when hub 43 detects a “link-down” condition, an appropriate signal will be conveyed from uplink port 432 to output ports 431a, 431b, 431c, and 431d, of hub 43. In practice, the predetermined signal may be conveyed from uplink port 431 to respective transceivers associated with the output ports.

Consequently, as a result of the appearance of a “link-down” indication at uplink port 432, a corresponding “link-down” signal is caused to appear at output ports 431a, 431b, 431c, and 431d. The link-down signals at ports 431b, 431c and 431d are coupled to network devices 461, 462 and 463, respectively, causing those devices to be powered-down, and effectively disconnected from the network.

In addition, the link-down signal that propagates from output port 431a is coupled to uplink port 442 of concatenated hub 44. In a manner directly analogous to what has been described above, network devices that are coupled to output ports 441a, 441b, 441c and 441d are also powered down, or effectively disconnected. In this manner a geometrically increased number of network devices can be controlled through the generation of a single signal that issues, or propagates, from a master network interface device, as the signal, or a derivative thereof, cascades through serially connected concatenated hubs. Note that even though only two hubs are shown as concatenated in FIG. 4, the subject invention is readily extensible to a greater number of concatenated hubs.

Accordingly, from the Description above, it should be abundantly clear there has been presented herein a substantial advance in techniques for the control of a state of the PHY of network devices. To wit: the invention enables programmatic control of a PHY state of a DTE network device from a remote (i.e., master) network interconnect device, such as a switch or a router. The invention, in one embodiment, adroitly takes advantage of programmable capabilities of conventional network interconnect devices, (e.g., switches, routers, etc.) to achieve programmatic control of a state of the PHY of a DTE network device in a manner that had been heretofore unattainable. This capability enables backup DTE network devices to be connected/disconnected to/from a network as needed, without manual intervention. In addition, the technique is useful programming, testing, debugging, and verification phases of application development where dynamic network configuration rearrangements are required. Essentially, the invention enables programmatic control of a state of the PHY of a hub or a DTE network device, a heretofore nonexistent feature.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A system comprising:
a first network interconnect device to couple to a network;
a second network interconnect device comprising an uplink port and a device port;
a channel coupling the uplink port to the first network interconnect device, wherein the first network interconnect device is operative to transmit a predetermined signal to the second network interconnect device, the signal operative to control a state of the PHY of the second network interconnect device.

2. A system as defined in claim 1, wherein the predetermined signal controls the power state of the PHY of the second network interconnect device.

3. A system as defined in claim 2, wherein the signal is a heartbeat pulse.

4. A system as defined in claim 1, wherein the second network interconnect device is a hub.

5. A system as defined in claim 4, wherein the channel comprises a coaxial cable.

6. A system as defined in claim 5, wherein the signal controls the power state of the PHY of the second network interconnect device.

7. A system as defined in claim 6, wherein the signal is a heartbeat pulse.

8. A system as defined in claim 4, wherein the signal controls the power state of the PHY layer of the hub.

9. A method comprising;
coupling a master network interconnect device to a network;
coupling a slave network interconnect device to the master network interconnect device;
coupling the slave network interconnect device to a network device; and
transmitting a predetermined signal from the master network interconnect device to the slave network interconnect device so as to control a state of the PHY of the network device that is coupled to the slave network interconnect device.

10. A method as defined in claim 9, wherein transmission of the predetermined signal from the master network interconnect device to the slave network interconnect device is effective to control the power state of the PHY of the network device.

11. A method as defined in claim 9, wherein transmission of the predetermined signal from the master network interconnect device to the slave network interconnect device is caused to occur under program control.

12. A method as defined in claim 11, wherein transmission of the predetermined signal from the master network interconnect device to the slave network interconnect device is effective to control the power state of the PHY of the network device.

13. A method as defined in claim 12, wherein the predetermined signal is a heartbeat signal.

14. A method as defined in claim 9, wherein the slave network interconnect device comprises a hub having an uplink port to couple to the master network interconnect device and having at least one device port to couple to a network device.

15. A method as defined in claim 14, wherein the master network interconnect device transmits the predetermined signal to the hub over a transmission channel that couples the master network interconnect device to the uplink port of the hub.

16. A method as defined in claim 15, wherein transmission of the predetermined signal from the master network interconnect device to the slave network interconnect device is caused to occur under program control.

17. A method as defined in claim 16, wherein transmission of the predetermined signal from the master network interconnect device to the slave network interconnect device is effective to control the power state of the PHY of the network device.

18. A method as defined in claim 17, wherein the predetermined signal is a heartbeat signal.

19. In a network, an interconnect apparatus comprising:
a network interconnect device;
a first hub comprising a plurality of device ports and an uplink port;
a channel coupling the uplink port of the first hub to the network interconnect device;
a first network device coupled to a device port of the first hub; and
an article including a machine-readable storage medium onto which there are written instructions that, if executed by the network interconnect device, are effective to cause the network interconnect device to transmit a predetermined signal over the channel to the first hub so as to control a state of the PHY of a network device that is coupled to a device port of the hub.

20. An interconnect apparatus as defined in claim 19, wherein transmission of the predetermined signal over the channel to the first hub is effective to connect/disconnect the first network device to/from the network.

21. An interconnect apparatus as defined in claim 19, wherein transmission of the predetermined signal is effective to control the power state of the PHY of the first network device.

22. An interconnect apparatus as defined in claim 21, wherein the predetermined signal is a heartbeat signal.

23. An interconnect apparatus as defined in claim 19, further comprising:
a concatenated hub comprising a plurality of device ports and an uplink port coupled to a device port of the first hub; and
a second network device coupled to a device port of the concatenated hub.

24. An interconnect apparatus as defined in claim 23, wherein transmission of the predetermined signal over the channel to the first hub is effective to connection/disconnect the second network device to/from the network.

25. An interconnect apparatus as defined in claim 24, wherein transmission of the predetermined signal is effective to control the power state of the PHY of the second network device.

26. An interconnect apparatus as defined in claim 23, wherein the predetermined signal is a heartbeat signal.

27. A network comprising:
a first network interface device having a plurality of output ports, the first network interface device operable to selectively provide at an output port a predetermined signal that is effective to indicate the status condition of a link coupled to the output port;
a second network interface device having a plurality of device ports are having an uplink port coupled through the link to the output port of the first network interface device;
circuitry coupling the uplink port to at least one device port so that appearance of the predetermined signal at the uplink port is conveyed to the device port; and
a network device coupled to the device port.

28. A network as defined in claim 27, wherein the predetermined signal is effective to alternatively indicate to the second network interface an uplink condition or a downlink condition.

29. A network as defined in claim 28, wherein the second network interface device is operable to control a state of the PHY of the network device in response to the predetermined signal.

30. A network as defined in claim 29, wherein the second network interface device is operable to control the power state of the PHY of the network device so that the network device is caused to be in a power-down state in response to a link down condition and in a power-up state in response to a link up condition.
